(19) United States
(12) Patent Application Publication
(10) Pub. No.: US 2018/0227167 A1
(43) Pub. Date: Aug. 9, 2018

(54) SYSTEM, METHOD, COMPUTER PROGRAM AND DATA SIGNAL FOR FAULT DETECTION AND RECOVERY OF A NETWORK

(71) Applicant: Macau University of Science and Technology, Taipa (MO)

(72) Inventors: Zhiwu Li, Taipa (MO); Syrine Ben Meskina, Taipa (MO); Mohamed Khalgui, Carthage (TN); Narjes Doggaz, Taipa (MO); Naiqi Wu, Taipa (MO)

(21) Appl. No.: 15/427,171

(22) Filed: Feb. 8, 2017

(51) Int. Cl. H04L 12/24

(52) U.S. Cl. CPC H04L 41/0613; H04L 41/145; H04L 41/0609; H04L 41/048; H04L 41/0654

(57) ABSTRACT

A system for fault detection and recovery of a network includes a network simulation module arranged to receive component data regarding a plurality of components that form the network and simulate the network, a modelling module arranged to utilise the simulated network to model a number of faults in the network to determine the effect of the faults on the network, and a recovery module arranged to determine a solution to the fault on the network.

### TECHNICAL FIELD

The present invention relates generally to a system, method, computer program and data signal for fault detection and recovery of a network.

Embodiments of the invention find particular, but not exclusive, use in the area of fault detection and recovery of a network and in particular in “smart grids”.

### BACKGROUND ART

A new term has emerged to describe particular types of power networks. The term is “smart grid”. The term “smart grid” has no precise definition, but it is generally agreed that any power network that shares at least a number of “intelligent” characteristics may be called a “smart grid”. Intelligent characteristics include multi-service communication, reliability, security and safety, which in turn allow for real-time monitoring and supervision. Smart grids are an evolution of current electric grids, but with the added features of intensive use of communication technologies, the integration of renewable and green energies to decarbonizes power systems, as well as the improvement of both the security and reliability of the network and the addition of new smart electrical hardware devices such as meters, storage devices and sensors.

Failures and faults in power grids are generally caused directly or indirectly by isolated and undesirable system conditions such as short-circuit, overloaded loss of power plants, etc. Damaged components in the grids as well as the use of a classical centralized production architecture have encouraged researchers to focus on making changes to the power grid and associated infrastructure. Previous work as focused on deploying a so called multi-agent system (MAS) to ensure reliable communication between components of the network. However, while existing models provide a monitoring and reporting function, existing methods cannot deal with the failures themselves nor investigate the possible relationship between multiple failures. Each failure must be handled independently.

It is with this background in mind that the embodiments of the invention and the broader inventive concept have been developed.

### DISCLOSURE OF THE INVENTION

In a first aspect, the present invention provides a system for fault detection and recovery of a network, comprising a network simulation module arranged to receive component data regarding a plurality of components which form the network and simulate the network, a modelling module arranged to utilise the simulated network to model a number of faults in the network to determine the effect of the faults on the network, and a recovery module arranged to determine a solution to the fault on the network.

In one embodiment, the recovery module determines the solution by firstly determining a solution to a dominant fault.

In one embodiment, the network simulation module simulates a set of sub-networks.

In one embodiment, the modelling module determines the solution by firstly determining a solution to a dominant fault in each sub-network.

In one embodiment, the system utilises a distributed architecture.

In one embodiment, the distributed architecture utilises static and mobile agents.

In one embodiment, the modelling module uses the distributed architecture to determine a strategy for ameliorating the fault and/or dominant fault in the network or the each-sub-network.

In one embodiment, the modelling module is arranged to classify the faults into one or more categories.

In one embodiment, the system further including a communications module arranged to communicate the proposed solution to one or more of the components of a network.

In a second aspect, the present invention provides a method for fault detection and recovery of a network, comprising the steps of receiving component data regarding a plurality of components which form the network and simulate the network, modelling the simulated network to model a number of faults in the network to determine the effect of the faults on the network, and determining a solution to the fault on the network.

In a third aspect, the present invention provides a computer program incorporating at least one instruction, arranged to, when executed on a computing system, perform the method steps in accordance with the second aspect of the invention.

In a fourth aspect, the present invention provides a data signal encoding at least one instruction, arranged to, when received and executed on a computing system, perform the method steps in accordance with the second aspect of the invention.

In a fifth aspect, the present invention provides an electricity network incorporating a system in accordance with the first aspect of the invention, wherein the at least one device includes a physical component which is operated by the first aspect of the invention.

### BRIEF DESCRIPTION OF DRAWINGS

The invention is now discussed with reference to drawings, where:

FIG. 1 is a schematic diagram illustrating a system in accordance with an embodiment of the present invention;

FIG. 2 is a schematic diagram illustrating a smart grid;

FIG. 3 is a diagram illustrating an example fault on a sub-network of a smart grid;

FIG. 4 is a diagram illustrating an architecture of a MAS in accordance with an embodiment of the invention;

FIG. 5 is a network diagram illustrating the assignment of local recovery agents and instantiation of mobile recovery agents;

FIG. 6 is a schematic diagram illustrating a computer simulation package in accordance with an embodiment of the invention;

FIG. 7 is an image of an interface of the computer simulation package in accordance with an embodiment of the invention;

FIG. 8 is a diagram illustrating a UML class design with an embodiment of the invention;

FIG. 9 is a diagram illustrating a UML package design with an embodiment of the invention;

FIG. 10 is a diagram illustrating interaction between the layers of the proposed MAS architecture in accordance with an embodiment of the invention;

FIG. 11 is a graph illustrating the increase of fault numbers in terms of the occurrence of problems over different sub-grids as modelled by the computer simulation software;

FIGS. 12A, 12B, and 12C provide graphs illustrating the gain provided due to the use of fault categorisation in accordance with an embodiment of the invention;

FIGS. 13A, 13B, and 13C provide graphs illustrating the CPU usage for resolving problems in a modelled network in accordance with an embodiment of the invention; and

FIG. 14 is a graph illustrating an evolution of the number of exchanged messages in terms of problems and existing paths when utilising the computer simulation model in accordance with an embodiment of the invention.

### BEST MODES FOR CARRYING OUT THE INVENTION

The present invention relates generally to a system, method, computer program and data signal for fault detection and recovery of a network. The embodiments described herein are described with reference to smart power grids. However, it will be appreciated that the system, method computer program and data signal has application in other analogous areas.

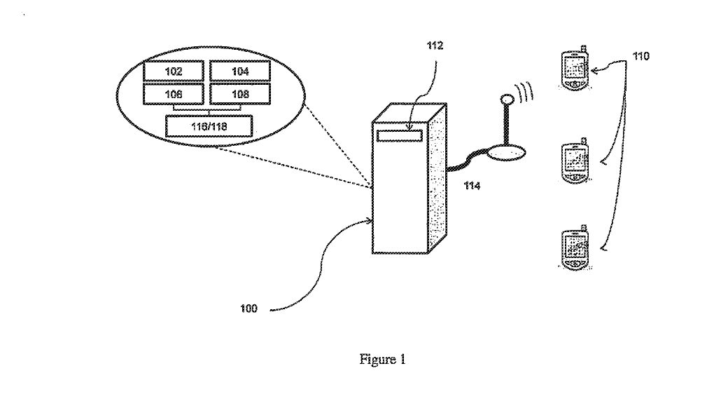

In FIG. 1 there is shown a schematic diagram of a computing system, which in this embodiment is a server 100 suitable for use with an embodiment of the present invention. The server 100 may be used to execute application and/or system services such as a system and method for the scheduling of various operations in accordance with an embodiment of the present invention.

With reference to FIG. 1, the server 100 may comprise suitable components necessary to receive, store and execute appropriate computer instructions. The components may include a processor 102, read only memory (ROM) 104, random access memory (RAM) 106, an input/output devices such as disc drives 108, remote or connected input devices 110 (such as a mobile computing device, a smartphone or a ‘desktop’ personal computer), and one or more communications link(s) 114.

The server 100 includes instructions that may be installed in ROM 104, RAM 106 or disc drives 112 and may be executed by the processor 102. There may be provided a plurality of communication links 114 which may variously connect to one or more computing devices 110 such as servers, personal computers, terminals, wireless or handheld computing devices, or mobile communication devices such as a mobile (cellular) telephone. At least one of a plurality of communications link 114 may be connected to an external computing network through a telecommunications network.

In one particular embodiment the device may include a database 116 which may reside on the storage device 112. It will be understood that the database may reside on any suitable storage device, which may encompass solid state drives, hard disc drives, optical drives or magnetic tape drives. The database 116 may reside on a single physical storage device or may be spread across multiple storage devices.

The server 100 includes a suitable operating system 118 which may also reside on a storage device or in the ROM of the server 100. The operating system is arranged to interact with the database and with one or more computer programs to cause the server to carry out the steps, functions and/or procedures in accordance with the embodiments of the invention described herein.

Broadly, the invention relates to a computing method and system arranged to interact with one or more remote devices via a communications network. The remote devices may take the form of other computing devices, as described above, but may also take the form of electronically operated devices, such as smart meters, switches, relays, circuit breakers, fuses, actuators, etc.

Other aspects of the broad inventive concept relate to a corresponding method, computer program and data signal. The method facilitates the scheduling of operations and the subsequent performance of such operations, by the use of a communications network which allows commands or data to send between one or more remote devices and one or more databases.

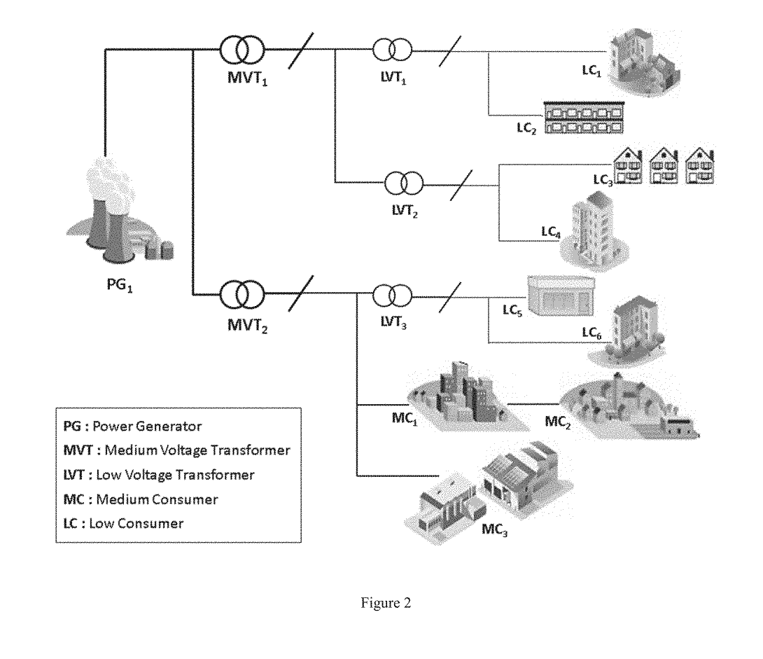

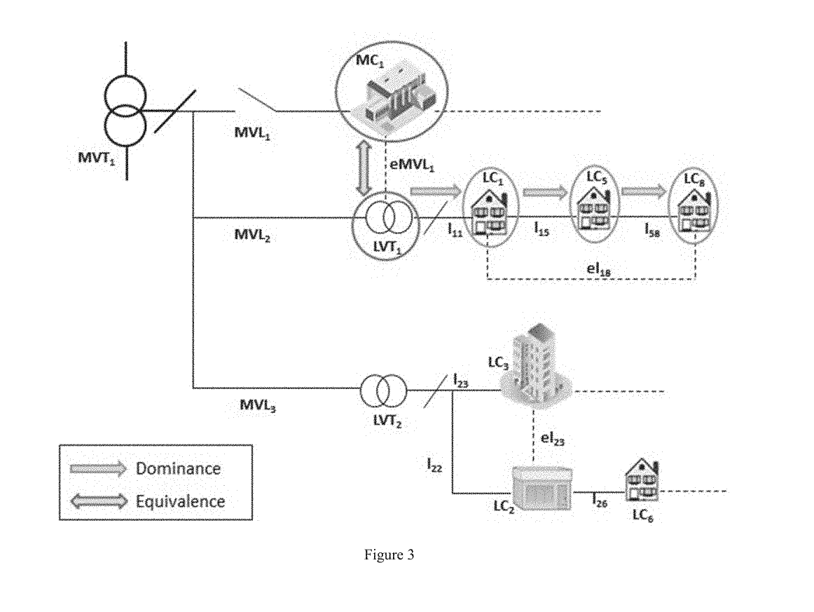

In order to describe the underlying inventive concept and the embodiments described herein, it is first necessary to describe a model of a smart grid. Typically, electrical networks contain three voltage levels: High (44 kV), Medium (11 kV) and Low (380V). The network includes a number of devices which either generate electricity or channel electricity (e.g. generators, transformers, consumers and actuators) and electrical lines connecting the different components of the electrical network. Hence, a smart grid is a network of electrical components and electrical lines. FIG. 2 illustrates an example of a small smart grid.

PG1 is a central production station. MC1, MC2 and MC3 are respectively commercial buildings, a village and factories. LC1, LC2, LC3, LC4, LC5 and LC6 are respectively apartment buildings, small commercial, homes, residential buildings, stores and a small clinic.

Before proceeding to a description of the embodiment, it is instructive to provide a description of the nomenclature which will be used in the ensuing description.

[symbol] denotes the universe of all electrical components (as per equation 1). This universe is composed of a set of power generators (PG), medium voltage transformers (MVT), low is voltage transformers (LVT), medium consumers (MC) and low consumers (LC):

[symbol]

=PG ∪ MVT ∪ LVT ∪ MC ∪ LC (1)

An electrical component c ϵ [symbol] is characterized by its activation state A(c), voltage level VL(c) and priority Pr(c) [51]. A(c) is equal to 1 if c is activated, 0 else. VL(c) is equal to 1, 2 or 3, respectively, for high, medium and low voltage levels. Pr(c) represents the priority of the component c in the smart grid. This priority indicates which consumers should be supplied at first compared to the others. Each generator g ϵ PG has a given produced power ProdPow(g).

A voltage transformer t ϵ MVT ∪ LVT is characterized by its transformed power TransfPow(t) while a consumer c ϵ MC ∪ LC is defined by its required load ReqL(c), its received load ReceivL(c) and its rank Rank(c) which is, in case of serial alimentation, its relative place in the graded supplying line. It is also necessary to define the position occupied by a consumer in order to draw conclusions about the fault propagation. The rank of a consumer c is calculated as follows, that is:

$$Rank ( c ) = \{ \begin{matrix}1 , if ∃ {l}_{xc} with x ∈ PG ⋃ MVT ⋃ LVT \\ 1 + Rank ( x ) , if ∃ {l}_{xc} with x ∈ MC ⋃ LC\end{matrix} \qquad ( 2 )$$

where l_{xc} is an electrical line going from the electrical component x to the consumer c.

[symbol] denotes the set of all electrical lines in Eq. (3). It is composed of high voltage lines (HVL), medium voltage lines (MVL) and low voltage lines (LVL):

[symbol]

=HVL ∪ MVL ∪ LVL (3)

An electrical line lᵢⱼ ϵ [symbol] is defined as the electrical line going from the component i to the component j (where i≠j). A line lᵢⱼ ϵ [symbol] has an activate state A(lᵢⱼ) equal to 1 if the line is activated and 0 if it is deactivated. It has also a voltage level VL(lᵢⱼ) equal to 1, 2 or 3 for, respectively, high, medium and low voltage levels. A high voltage line lᵢⱼ ϵ HVL has a transported load TranspL(lᵢⱼ) while each medium or low voltage line lᵢⱼ ϵ MVL ∪ LVL has a distributed load DistL(lᵢⱼ).

The set of lines [symbol] is composed of a set of principal lines (PL) which are initially activated and a set of emergency lines (EL) initially deactivated. The emergency lines will be activated when the principal lines are in failure, that is:

[symbol]

=PL ∪ EL

PL={lᵢⱼ ∈ L/A(lᵢⱼ)=1}

EL={lᵢⱼ ∈ L/A(lᵢⱼ)=0} (4)

For each component n ϵ [symbol] , four functions are defined, Father(n), Brother(n), Neighbor(n) and Child(n), that is:
Father(n) is the electrical component supplying n and belonging to the voltage level above. This function returns the component n₁ ϵ [symbol] having a higher voltage level and connected to n, through a line or a path, that is:

n₁=Father(n)if VL(n₁)=VL(n)+1, n₁≠n, and ∃ lₙₗₙ ∈ L or ∃ path(n₁, n) (5)

where path(n₁, n) is a set of electrical lines going from the component n₁ to the component n.
Brother(n) is the set of components n₂ ϵ [symbol] belonging to the same voltage level with n and having the same father with n, that is:

Brother(n)={n₂ ∈ [symbol] /Father(n₂)=Father(n), VL(n₂)=VL(n)and n₂≠n} (6)
Neighbor(n) is the set of components n₃ ϵ [symbol] belonging to the same voltage level with n and having the same grandfather with n, that is:

Neighbor(n)={n₃ ∈ [symbol] /VL(n₃)=VL(n), Father(n₃)∈ Brother(Father(n)), n₃≠n and [symbol] lₙₙ₃ ∈ PL} (7)
Child(n) is the set of the electrical components supplied by n and belonging to the voltage level below. This function returns the set of electrical components n₄ ϵ [symbol] for which the father is the component n, that is:

Child(n)={n₄ ∈ [symbol] /n=Father(n₄)and n₄≠n} (8)

A smart grid SG is defined as an oriented graph describing a network of nodes belonging to [symbol] and a set of edges that are the electrical lines [symbol] , that is:

SG=G( [symbol] , [symbol] ) (9)

A smart sub-grid is defined over a component n ϵ C as the sub-graph G( [symbol] ₙ, [symbol] ₙ)⊂ SG. The set of nodes [symbol] ₙ contains the component n and its children and [symbol] ₙ is the set of lines connecting the components belonging to [symbol] ₙ. It is important to notice that smart sub-grids are defined only for is the nodes having children. That is:

$$SSG ( n ) = \{ \begin{matrix}φ , if Child ( n ) = φ \\ G ( {𝒞}_{n} , {ℒ}_{n} ) , otherwise\end{matrix} \qquad ( 10 )$$

where [symbol] ₙ={n} ∪ Child(n) if Child(n)≠Ø and [symbol] ₙ={lᵢⱼ ϵ [symbol] /i ϵ [symbol] ₙ and j ϵ Child(n)}

The robustness of electrical grids is determined by their ability of managing and facing all eventual submerging problems. A problem occurs when there is at least one violated constraint and thus may engender multiple faults. A fault f(x) occurs on x with (x ϵ [symbol] ∪ [symbol] ) when there is a violation on x of at least one of the operational constraints [51] which are: (i) the activation constraint, (ii) the stability constraint which has to maintain the frequency of all electric components and the voltage of all electric lines approximately equal to the prefixed default values and (iii) the flowing load constraint. The last constraint allows us to verify if there is an under-voltage or over-voltage problem. The encountered faults can easily propagate from the sub-grid on which it occurs to another as the power system is a meshed network composed of inter-connected electric components. The faults are usually propagated by means of electrical lines along the same voltage level (intra-level) or even between different voltage levels (inter-level) and may affect the hardware devices.

A problem [symbol] ₙ encountered on a smart sub-grid SSG(n)=G( [symbol] ₙ, [symbol] ₙ) is the set of faults occurring on the components and lines belonging to SSG(n).

[symbol]

ₙ={f(x)∈ [symbol] /x ∈ [symbol] ₙ ∪ [symbol] ₙ} (11)

where [symbol] is the fault set containing all the faults occurred over an SG.

As the dissatisfaction of only one constraint can engender multiple consequent faults, it is necessary to minimize the faults to be resolved. To achieve this aim, it is necessary to construct new definitions for dominant and equivalent faults based on new relations.

Definition 1: (Dominant Fault) Let us consider a component x connected to a set of components Y such that both of them belong to the same smart sub-grid SSG(n). Let f(x) be a fault on the component x and [symbol] ′ be a fault subset such that both f(x) and [symbol] ′ belong to [symbol] ₙ and, in addition, | [symbol] |=|Y|. f(x) is said to be dominant with respect to a fault f′(yⱼ) on a component yⱼ, denoted by f(x)→f′(yⱼ), if ∀f′(yⱼ)∈ [symbol] ′, yⱼ ∈Y for j=1, . . . , | [symbol] ′|:

$$\{ \begin{matrix}VL ( x ) < VL ( {y}_{j} ) \\ or \\ VL ( x ) < VL ( {y}_{j} ) and \\ Rank ( x ) < Rank ( {y}_{j} )\end{matrix} \qquad ( 12 )$$

The advantage of classifying faults into dominant and dominated ones lies principally in reducing the number of faults to be handled and resolved. In fact, the resolution of only one category of them resolves the problem. The resolution of a dominant fault—engendering many other dominated ones—resolves all the problem. This strategy allows the reduction of the required time of resolution as the focus is applied to investigating and resolving only one fault: the dominant one.

Definition 2: (Equivalent Fault) Let x and y be two connected components belonging to the same smart sub-grid SSG(n). Let f(x) and f(y) be two faults of [symbol] ₙ occurring respectively on the components x and y. Faults f(x) and f(y) are said to be equivalent, denoted by f(x)⇔ f(y), if

VL(x)=VL(y)and Rank(x)=Rank(y) (13)

In order to decrease the required time for power system recovery, it is necessary to reduce the cost of the resolution procedure while trying to solve the maximum of the occurred faults. Thus, these new relations facilitate the failure recovery and allow the control and the reduction of the number of faults to be recovered in order to recover the total problem. In fact, the resolution of only one of the equivalent faults can resolve the problem. This advantage is particularly observed in the case of multiple equivalent faults as the focus is on resolving only one of them.

Let Vₘₐₓ be the higher voltage level over SSG(n) and [symbol] ₘₐₓ ⊂ [symbol] ₙ be the set of faults assigned to the components belonging to the Vₘₐₓ voltage level, that is:

[symbol]

ₘₐₓ={f(c)∈ [symbol] ₙ/VL(c)=Vₘₐₓ and c ∈ SSG(n)} (14)

The sets of Dominant Faults DF( [symbol] ₙ), dominated Faults dF( [symbol] ₙ) and Equivalent Faults EF( [symbol] ₙ) are defined by:

$$\{ \begin{matrix}DF ( {𝒫}_{n} ) = {𝒫}_{max} , if \vert {𝒫}_{max} \vert = 1 \\ dF ( {𝒫}_{n} ) = {𝒫}_{n} \backslash \vert {𝒫}_{max} , \\ EF ( {𝒫}_{n} ) = {𝒫}_{max} , if \vert {𝒫}_{max} \vert > 1\end{matrix} \qquad ( 15 )$$

In order to illustrate the presented fault categorization strategy, let us consider the power sub-grid SSG(MVT₁) in FIG. 2, where [symbol] ₁={MVT₁, MC₁, LVT₁, LVT₂, LC₁, LC₅, LC₈, LC₃, LC₂, LC₆} is the set of components of SSG(MVT₁), [symbol] ₁ is the set of lines of SSG(MVT₁) composed of the set of principal lines PL₁={MVL₁, MVL₂, MVL₃, l₁₁, l₁₅, l₅₈, l₂₃, l₂₂, l₂₆}, and EL₁={eMVL₁, el₂₃, el₁₈} the set of emergency lines.

Let us assume now that A(MVL₁)=0 and A(eMVL₁)=1 due to a line switching off. In addition it is assumed that there is a fault f(MVL₂) observed on the line MVL₂ due to an instability voltage problem. The fault f(MVL₂) involves the emergence of the new fault f(LVT₁) on the low voltage transformer LVT₁ and continue to propagate to the connected devices. It is denoted respectively by f(LC₁), f(LC₅), f(LC₈) and f(MC₁) the faults consequently occurred on the low consumers LC₁, LC₅, LC₈, and on the medium consumer MC₁. According to the proposed categorization, the faults f(LVT₁) and f(MC₁) are equivalent while the faults f(LC₁), f(LC₅), f(LC₈) are dominated by f(LVT₁).

The resolution of the dominant fault resolves all the problem (including the dominated ones). When the resolution of the dominant fault is not possible, the adopted strategy consists of searching a solution for the dominated faults. Thus, the majority of the encountered problems are resolved except the dominant fault. For that, the same step of fault categorization is performed over the set of the dominated faults. In the case of equivalence, the resolution of only one of the equivalent faults can resolve all the problem. The advantage is particularly observed in the case of more than one occurred fault, the proposed methodology focuses on solving only one or a subset of them. For example, since f(LVT₁) and f(MC₁) are two equivalent faults, the resolution of only one of them solves all the problem.

The fault categorization is an important concept in the proposed approach to identify the relevant set of failures to be recovered as well as the order in which they will be resolved. This strategy allows to reduce the required time of resolution by reducing the number of instructions to be performed.

The proposed multi-agent architecture used to detect faults in power smart grids and recover them dynamically is now described.

A power system environment has two main characteristics: dynamic and unpredictable. Indeed, a power system can change during a recovery operation as switching on or off of electric components, failure occurring, etc. The resolution of an occurred problem [symbol] ₙ is resolved first locally within the sub-smart grid SSG(n). In the case where no local solution is found, a global solution from the other sub-grids is then investigated. For this purpose, the use of a distributed system decentralizing the control and the recovery and more precisely the use of a multi-agent system is beneficial. Through the use of MAS it is possible to represent as near as possible the real behavior of the physical power grid by using the developed simulator. As power grids undergo changes from centralized to decentralized, integration of distributed energy generators increasing size and more complex topology. This implies the requirement of new supervisory control with new and smart considerations. The software agents are helpful to perform some tasks such as smart grid supervision by checking operating constraints, fault isolation, fault classification and automatize some others like smart grid control and search for local or non-local solutions. Motivated by these considerations, intelligent agents were deployed to simulate the dynamic behavior of power networks by simulating the heterogenous devices consuming, producing and/or transforming power energy.

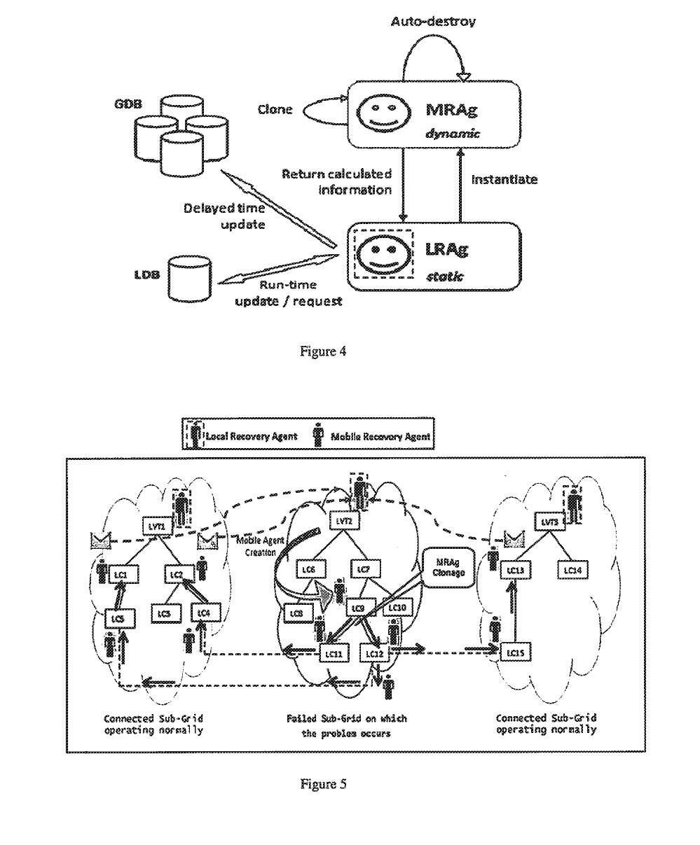

The proposed MAS is composed of two types of agents: static local recovery agents (LRAg) and mobile recovery agents (MRAg). FIG. 4 illustrates the architecture of the proposed MAS. These agents interact and collaborate together in order to maintain the stability and the effective functioning of the power grid. The task of the proposed agents is to maintain the proper functioning of the electrical network by detecting and recovering efficiently the occurred faults.

1) Local Recovery Agents (LRAg): The goal of a local recovery agent is to maintain the proper functioning of the power sub-grid under its scope. For this purpose, each LRAg is assigned a set of rules describing its behavior and a local data base (LDB). The LDB contains all the information about the supervised power sub-grid as well as the solutions found thanks to the mobile agents. This consideration alleviates the data access, storage and control as well as the agents processing. The LDBs are updated at run-time. There is provided a global data base to be updated in delayed time (when the agents are available). It is related to the whole power network and contains all the information about the simulated SG. It is useful for keeping track and saving history on the one hand. On the other hand, this data is significant to perform eventual analysis and studies about the most critical zones/areas, learning task, etc.

In order to reduce the communication cost, one LRAg is associated—denoted by LRAgₙ—with each non empty electrical smart sub-grid SSG(n)⊂ SG (Eq. (16)). Hence, an LRAg is assigned to each power generator and voltage transformer. The deployed LRAgs have then to supervise the concerned component as well as the components indirectly supplied belonging to the voltage level below. Hence,

∀ SSG(n)⊂ SG, ∃ LRAgₙ/SSG(n)≠Ø (16)

When an LRAg detects a fault due to a violated constraint, it begins by isolating the component or line responsible of the failure in order to avoid the failure propagation. Then, the LRAg proceeds to recover this failure. For that, it searches over its supervised sub-grid for a solution. When no local solution is found, the LRAg requests the LDB about a solution already found for the encountered problem. If no solution for the occurred fault is stored in its LDB, the LRAg searches for a cooperative solution from the neighbor sub-grids. For that, the LRAg creates an MRAg to obtain information about the components belonging to the connected sub-grids (FIG. 4). Then, according to the results given by the MRAg, the LRAg decides the action to undertake. If a new solution is found, the LDB should be updated

2) Mobile Recovery Agents (MRAg): The mobile recovery agent is a software entity moving, through electrical lines, from the failed sub-grid to the other functional ones connected through emergency lines. These deployed mobile agents avoid any required protocol based on exchanged messages between agents to arrange faults. Agents are based on the FIFO policy when concurrent faults have to be recovered. An MRAg is created on the failed component(s) on which the fault(s) occur(s) by the LRAg supervising the failed sub-grid. Then, it moves through the existing lines, called paths, to visit the connected electric devices. When the visited component has more than one outgoing line (connected to more than one component), the MRAg will be duplicated or cloned in order to investigate all the existing paths. The duplicated MRAg are called clones.

At each visited component, the MRAg performs some calculations: cumulative remaining load and priority. When it reaches the end of the visited path, e.g., there is no component to be visited, it should notify the LRAg by sending a message. This message contains the calculated values. Once the end of the path is reached, the MRAg is destructed. It can be also destructed before reaching the end of the path when it finds a negative calculated cumulative remaining load. This alternative cannot present a candidate solution as it is unfeasible. Each electric

The proposed agents act autonomously and collaborate together to maintain the proper functioning of the power network. To each deployed agent, there are attributed the key four properties, which are:
Autonomy: a deployed agent is able to operate regardless of any other human or software intervention. For example, the search for local and non-local solutions performed respectively by LRAg and MRAg.
Social ability/interactivity: each agent of the deployed ones is able to interact, via its environment, with the others in order to reach the global objectives defined beforehand or to accomplish the required tasks. For example, there is a communication between the LRAg and the instantiated MRAg to find and execute the most useful feasible remote solution.
Responsiveness: a deployed agent is able to observe and perceive—through its sensors—its environment (SG). It is also able to respond to the observed changes (violated operating constraints) by taking the suitable actions (fault isolation, start-up of the search for solution, etc.).
Proactivity/Proactive ability: a deployed agent is always ready to react and take the initiative whenever the situation demands to reach its own objective or even the global objectives of the MAS.

Besides these characteristics, the deployed mobile agents have a main supplementary characteristic which is mobility as it can merge from a host (electrical component) to others.

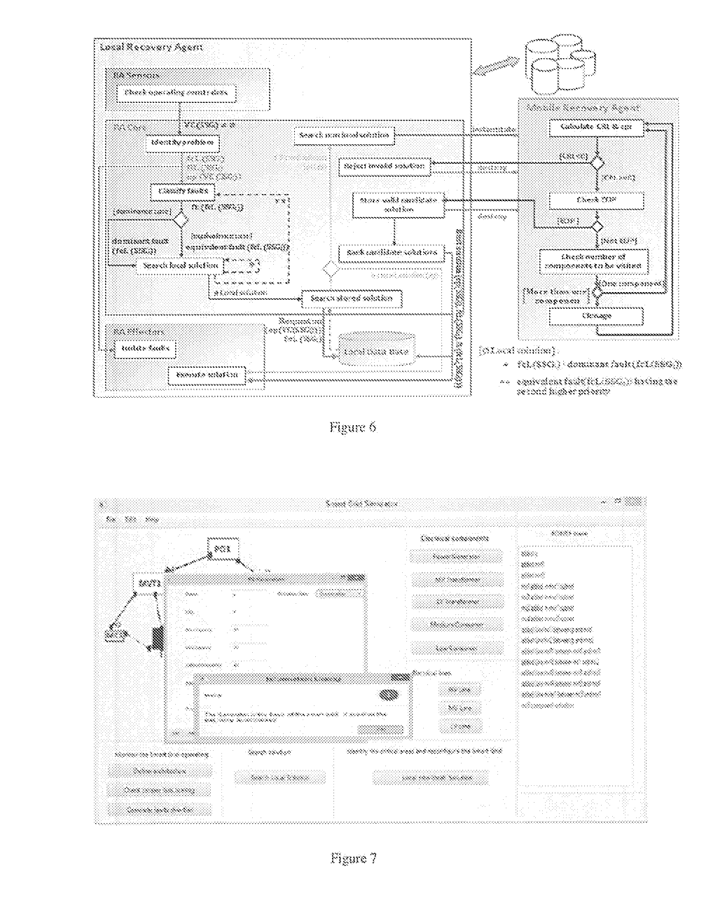

Smart grid recovery is a run-time process to handle the detected faults occurring over the modeled and simulated power smart grid SG with the proposed environment FDIRSY. In fact, this process consists in searching the possible solutions that keep the system in an acceptable behavior. The fault recovery strategy is described with reference to FIG. 6.

Each SSG(n) on a component n is continuously supervised by the corresponding local recovery agent LRAgₙ. The sensors of LRAgₙ check continuously the operating conditions in order to detect any changes. The unsatisfaction of the operating conditions over an electrical component or an electrical line causes the apparition of failures. In fact, a failed line implies the failure of the supplied components by propagation. It is not possible to resolve the failures occurred over the electrical lines—except the switching off problem—since it requires generally the human and physical intervention. However, it is possible to investigate and exploit the emergency lines to handle and resolve the failures occurred over the electrical components.

In this example, the inventors deal only with the faults occurred over the electrical components. Each failed component corresponds to a fault. Thus, all the failed components must be isolated to avoid their propagation to the other connected sub-grids and components (the non failed ones). This step is ensured by the LRAgₙ that deactivates the failed devices and lines. After that, LRAgₙ proceeds to the classification of the detected faults by equivalence or by dominance. In fact, it is on the base of this fault classification that the local recovery agent builds its resolution strategy. Thus, LRAgₙ favors first the dominant faults. If the dominant fault cannot be resolved, then LRAgₙ tries to resolve the dominated ones. Before the resolution of the dominated faults, a new classification on the set of dominated faults is processed. This step is needed to allow the LRAgₙ in determining the best order for fault resolution. In the case of equivalence, the local recovery agent tries to resolve at first the equivalent fault corresponding to the component having the higher priority. If there is no solution for this fault, it looks for resolving the equivalent fault corresponding to the component having the second higher priority.

Once the faults to be resolved at first are identified, a local search for the solutions on the corresponding failed component(s) will be performed. A local search for solutions consists in finding the set of local emergency lines (⊂ SSG(n)) which income to the failed components. This line presents a solution and will be activated if it is able to supply sufficiently the failed components. The set of local solutions, found by LRAgₙ for a given fault f(c) on a component c belonging to SSG(n), is denoted by SetLocSol(f(c), LRAgₙ). The local solutions emanate from the components belonging to SSG(n) that are the brothers and the father of c or brothers and children of c, that is, Brother(c)∪(Father(c)⊕ Child(c)). That is:

SetLocSol(f(c), LRAgₙ)={l_{uc} ∈ EL ∩ [symbol] ₙ/RemainingLoad(u)≥RequiredLoad(c), A(l_{uc})=0 and u ∈ [symbol] ₙ} (17)

When no local solution is found, LRAgₙ looks for a non-local stored solution on its LDB. If a solution exists, LRAgₙ will execute it. When no stored solution, LRAgₙ instantiates the mobile recovery agents for searching a cooperative solution from the other connected sub-grids. The mobile recovery agents are created on the failed components by using the same strategy of fault managing described above. In fact, a mobile recovery agent MRAg_{c} is created by LRAgₙ on the failed component c when there is no local solution, that is:

if SetLocSol(f(c), LRAgₙ)=Ø, then ∃ MRAg_{c}/c ∈ SSG(n) and f(c)∈ [symbol] ₙ (18)

The procedure of searching non-local solutions requires an interaction between LRAgₙ and the created mobile recovery agents. Each of the created mobile recovery agents must calculate both cumulative remaining load (CRL) and cumulative priority (CPr) at each visited component. If the calculated CRL is negative, the investigated alternative presents an invalid solution which will be rejected. In this case before its destruction, the mobile recovery agent in question sends a message containing the calculated values to the creator LRAgₙ. However, if CRL is positive, the mobile recovery agent can eventually continue on its way.

During the path to follow, MRAg, looks at the number of the components connected to the visited one (that is, according to the number of the outgoing lines). When there is no component to be visited and CRL>0, this mobile recovery agent reaches the end of the taken path (EOP). Then, it will be destructed after sending a message to the creator LRAgₙ. The investigated alternative presents a candidate solution which will be stored in a temporary memory by LRAgₙ. When there is only one component to be visited (only one outgoing line), the mobile recovery agent will move to the connected component on which it will perform the required calculations. If there is more than one component to be visited (more than one outgoing line), the mobile recovery agent will be cloned such that each clone visits one connected device and performs the same procedure until reaching the EOP or a negative CRL.SetRemSol(f(c), MRAg_{c}), the set of remote solutions found by MRAg_{c} for a given fault f(c)ϵ [symbol] ₙ on a component c ϵ SSG(n). This solution set includes the deactivated non-local emergency lines procuring sufficient remaining load to supply the failed component c. In fact, the non-local solutions found emanate from Neighbor(c)∪(Father(c)⊕ Child(c)). That is,

SetRemSol(f(c), MRAg_{c})={l_{uc} ∈ EL\ [symbol] ₙ/RemainingLoad(u)≥RequiredLoad(c), A(l_{uc})=0 and u ∈ [symbol] \ [symbol] ₙ} (19)

Once LRAgₙ collects all the candidate solutions on its temporary memory, it proceeds to rank them to execute the most useful one according to a multi-objective function (Eq. (20)) taking into account the two calculated cumulative values CRL and CPr, that is:

$$Min CRL and Max CPr \\ Subject to . \\ CRL \geq ReqL ( {𝒫}_{n} ) \qquad ( 20 )$$

where ReqL( [symbol] ₙ) is the required load by all the failed components of the occurred problem [symbol] ₙ over the smart sub-grid SSG(n) obtained by

ReqL( [symbol] ₙ)=Σ ReqL(c), ∀ c ∈ [symbol] ₙ

and

CRL=Σ RemainL(c), ∀ c ∈ the visited path

The chosen solution among the found ones in SetRemSol(f(c), MRAg_{c}) or SetLocSol(f(c), LRAgₙ), corresponds to the one having the smaller CRL satisfying the requirements ReqL( [symbol] ₙ) of the occurred problem [symbol] ₙ and coming from the components with a lower priority.

The proposed fault recovery method has the advantage to be complete. Thus, if a solution exists, the proposed MAS will find it. Denote the solution set for a given fault f(c) on a component c ϵ SSG(n) by S(f(c), SSG(n)). It is obtained, as in (21), by the union of the set of local solutions and the set of remote solutions respectively represented by Eqs. (17) and (19).

S(f(c), SSG(n))=SetLocSol(f(c), LRAgₙ)∪ SetRemSol(f(c), MRAg_{c}) (21)

A problem [symbol] ₙ occurring on the sub-grid SSG(n) can be completely or partially resolved. The complete resolution of [symbol] ₙ is expressed by the predicate TotalResolution( [symbol] ₙ) as in (22). [symbol] ₙ is said to be totally resolved if there is a solution for each fault f(c)ϵ [symbol] ₙ where c ϵ SSG(n).

TotalResolution( [symbol] ₙ)=1, if ∀ f(c)∈ [symbol] ₙ, S(f(c), SSG(n))=Ø (22)

The partial resolution of [symbol] ₙ is expressed by the predicate PartialResolution( [symbol] ₙ) as in (23). In fact, [symbol] ₙ is said to be partially resolved if there exists at least one fault f(c₁)ϵ [symbol] ₙ that has a solution and one fault f(c₂)ϵ [symbol] ₙ that has no solution (neither local nor remote). That is:

PartialResolution( [symbol] ₙ)=1, if ∃(f(c₁), f(c₂))∈ [symbol] ₙ², /S(f(c₁), SSG(n))=Ø and S(f(c₂)), SSG(n))=Ø (23)

Theorem 1. The recovery protocol is complete.

For each fault f(x) belonging to the problem [symbol] ₙ occurred in the smart sub-grid SSG(n)⊂ SG, if there exists a local or non-local solution s, FDIRSY will necessary find it.

Proof. Perform a reasoning by absurdity to prove the completeness of the proposed protocol. Let us suppose that the protocol is not complete. That is, there is no possible resolution—neither local nor remote—for the problem [symbol] ₙ occurred over SSG(n). Thus:

TotalResolution( [symbol] ₙ)≠1−→S(f(c), SSG(n))=Ø ∀f(c)∈ [symbol] ₙ

and

PartialResolution( [symbol] ₙ)≠1−→S(f(c), SSG(n))=Ø ∀f(c)∈ [symbol] ₙ

Since the protocol is assumed by absurdity to be not complete, it can be concluded that there exists a solution s′ ϵ S(f(c), SSG(n)) such that s′ was not found by the proposed recovery protocol but by another one. A solution s′ consists in a deactivated emergency line incoming to the failed component c and having sufficient remaining load to supply c. This means that

∃s′ ∈ S(f(c), SSG(n))−→s′=l_{uc} ∈ EL/A(s′)=0, RemainL(u)≥ReqL(c) and u≠c

Hence, the solution s′ comes from the father, brother, child or neighbor of c, that is:

u ϵ Brother(c) ∪ Father(c)∪ Child(c)∪ Neighbor(c)−→s′ ϵ local solutions ∪ remote solutions−→s′ ϵ SetLocSol(f(c), LRAgₙ)∪ SetRemSol(f(c), MRAg_{c})−→s′ ϵ S(f(c), SSG(n))⇒absurdity

No other algorithm provides a solution not yet found by the protocol. In fact if a solution s exists, it comes from the father, brother, child or even a neighbor of x. Thus, s belongs to either local or remote solutions. However, all these alternatives are provided by local or remote solution(s).

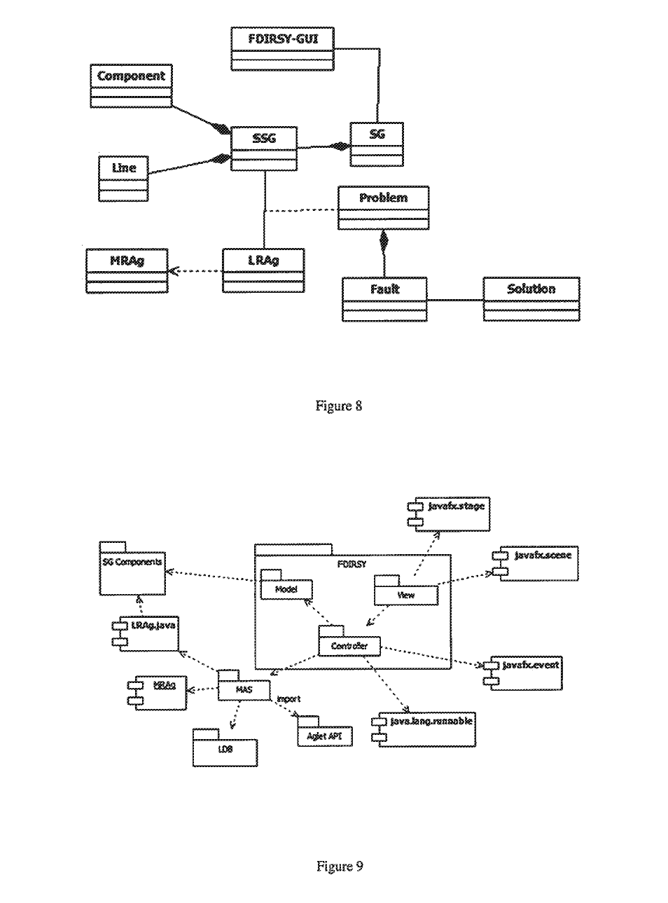

To test and validate the approach, a framework for power systems simulation and modeling named FDIRSY was developed. FDIRSY allows users to model and design a smart grid to be studied, configure its structure and simulate its functioning and behavior. The users interact with FDIRSY through a Graphical User Interfaces based on HMI and forming the Interface Layer. FDIRSY allows the parametrization of the deployed electrical lines and components (FIG. 7). To achieve the implementation of the proposed software simulator, there was performed a design step using UML diagrams. The FIGS. 8 and 9 illustrates respectively the class and package diagrams.

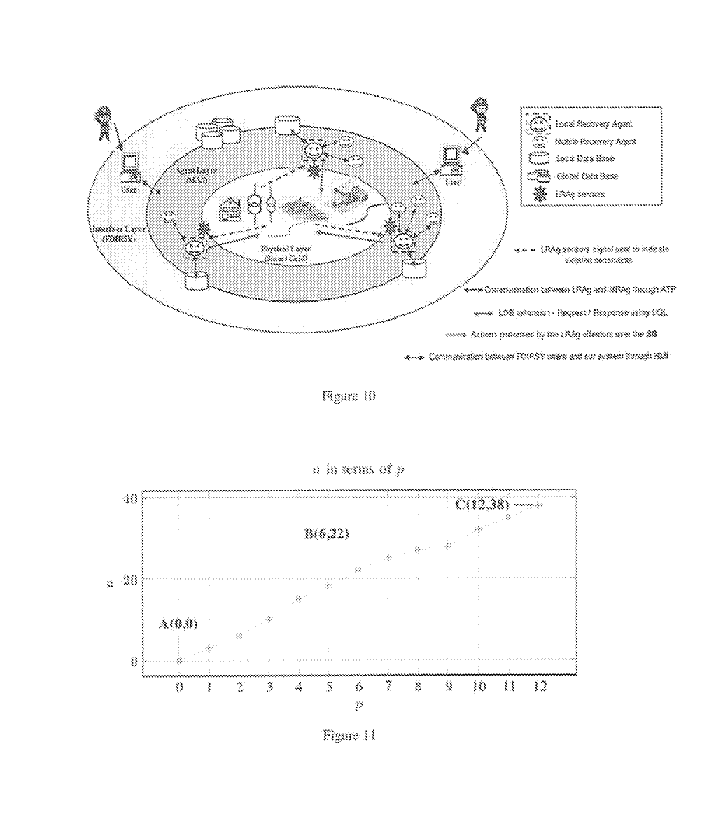

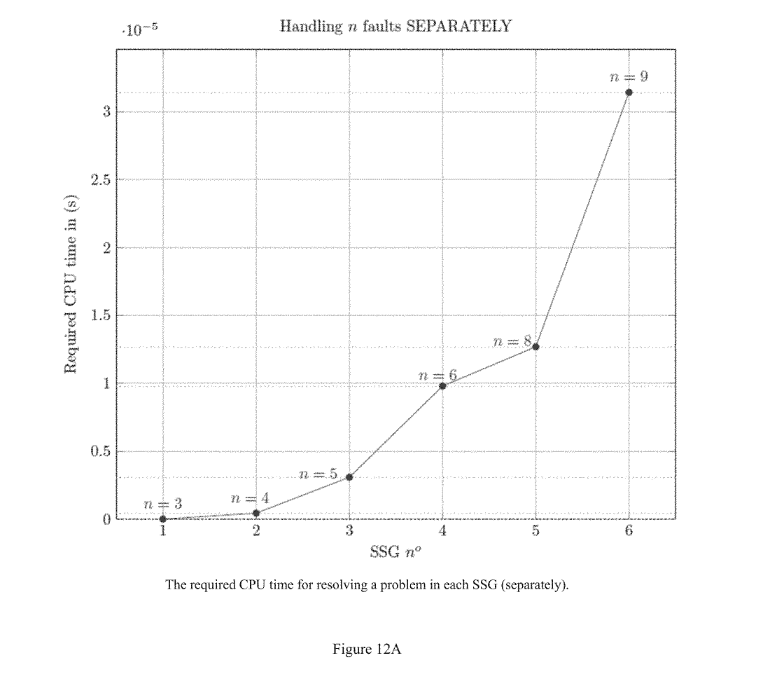

The software architecture of FDIRSY is illustrated in FIG. 10. The agent layer comprises the agents deployed in the proposed MAS: local recovery agent (LRAg) and mobile recovery agents (MRAg). The proposed mobile and static agents are implemented in Java. There are several platforms for developing mobile agents such as Aglets, Voyager, TACOMA, PIAX, JADE, SMARD, Agent TCL, SPRINGS, and Telescript.

The embodiment utilizes Java Aglet Application Programming Interface (JAAPI) to develop the proposed mobile agents. Java is originally implemented by Oshima and Lange at the IBM Tokyo Research Laboratory. The communication between the mobile recovery agents and the corresponding local recovery agents is ensured thanks to the agent transfer protocol (ATP) by using the ATP-package. The created mobile recovery agents can therefore access to the data and features of the visited host, that is, electrical component. The state of an MRAg includes the execution state of its thread as well as all the information relative to the recipient component. An eventual failure on a mobile agent, does not cancel the recovery procedure as the other instantiated mobile agents may return other possible solutions. Moreover in the case of failure, the local recovery creator can instantiate another mobile agent to visit the same path. Thus, only the local recovery agent creator will not benefit of the solution eventually returned by the failed mobile agent.

The used LDB is manipulated (requested and/or extended) only by the corresponding local recovery agent through an SQL software package. The physical layer corresponds to the simulated smart grid. In fact, it contains all the deployed electrical devices and lines. It presents the environment observed by the sensors of the local recovery agents to signal any changes (violated constraints). Face to the detected changes, the deployed local recovery agents should react upon their environment, that is, the simulated smart grid, due to their effectors (actuators) to isolate faults and execute solutions (activation/deactivation of components and lines).

o conduct an experimental study, five different smart grids were developed based on real meshed power networks of the Tunisian power system. The studied smart grids were simulated by FDIRSY and were carefully chosen to enable a large wide of experimentations. FDIRSY is implemented and executed on a Windows 7 machine with Intel Core i3, 1.8 GHz

In more detail, the following smart grids were modelled: (i) two small smart grids SG1 and SG2 composed, respectively, of small and large sub-grids, (ii) one medium smart grid SG3 composed of 12 sub-grids and (iii) two large smart grids SG4 and SG5 composed, respectively, of small and large sub-grids (Table I).

TABLE I
Smart Grids modelled

| | | Structure | | | Remarks | | |
|---|---|---|---|---|---|---|---|
| | Number | HV | MV | LV | SSG | Smaller | Bigger |
| SGN | of SSG | Level | Level | Level | Size | SSG | SSG |
| SG1 | 5 | 1 PG and 2 HVL | 2 MVT, 3 MC, | 2 LVT, 7 LC, | Small to | 3 nodes | 4 nodes |
| | | | 5 MVL and 2 eMVL | 7 LVL and 4 eLVL | medium | | |
| SG2 | 6 | 1 PG and 2 HVL | 2 MVT, 12 MC, | 3 LVT, 19 LC, | Large | 5 nodes | 12 nodes |
| | | | 15 MVL and 7 eMVL | 19 LVL and 9 eLVL | | | |
| SG3 | 12 | 2 PG and 4 HVL | 4 MVT, 7 MC, | 6 LVT, 19 LC, | Medium | 3 nodes | 5 nodes |
| | | | 13 MVL and 5 eMVL | 19 LVL and 8 eLVL | | | |
| SG4 | 18 | 2 PG and 7 HVL | 7 MVT, 11 MC, | 9 LVT, 19 LC, | Small to | 3 nodes | 4 nodes |
| | | | 17 MVL and 6 eMVL | 19 LVL and 12 eLVL | medium | | |
| SG5 | 19 | 2 PG and 5 HVL | 5 MVT, 9 MC, | 12 LVT, 42 LC, | Large | 5 nodes | 9 nodes |
| | | | 21 MVL and 4 eMVL | 42 LVL and 27 eLVL | | | |

where HV = High Voltage, MV = Medium Voltage, and LV = Low Voltage

To test and validate the proposed approach, a number of faults were manually injected at each of experiments one and two, and n faults that may engender others by propagation. These fault injections are performed by modifying the parameters of the electrical components of the simulated grids (like switching-off an electrical component, modifying the power produced by generators, changing the load required by a consumer and making it higher than the received load in order to generate failures, etc.). The new bad parameters are introduced by means of the FDIRSY User Interfaces based on HMI for parameterizations.

An occurred fault over a sub-grid will generally propagate to the other non-failed components through the existing electrical lines engendering the occurrence of other faults. According to Equation (11), this fault set forms a problem over this sub-grid. Thus, the occurrence of n faults over p different sub-grids belonging to the same smart grid lead to the apparition of p problems. By adding the consequently propagated faults, a fault number is obtained which is important compared to the problem number, that is, n faults>p problems. By increasing the fault number as illustrated by FIG. 10 for the studied smart grid SG3, where p is the number of the problems and n is that of faults. The point A(0,0) corresponds to the operational SG3 case without any problems and then 0 fault. The point B(6, 22) corresponds to the case of 6 occurred problems involving 22 faults. The point C(12, 38) corresponds to the total failure state of the whole SG3 with 12 problems (1 problem per sub-grid) involving 38 faults (1 fault per electrical component).

n depends highly on the complexity and the size of the smart grid as well as the included sub-grids (the number of included components and lines). The number of faults to be resolved becomes important and thus the resolution task may be complicated and slow. Therefore, fault categorization is provided which aims to reduce the number of faults to be handled and identify which parties are responsible for identifying faults.

In the modeling, three main cases are selected. Faults are recovered separately without performing a classification task as done in the literature. For that, 6 different sub-grids are selected with different sizes from the 5 studied smart grids to investigate the impact of fault classification on the CPU time required by the recovery procedure.

The three cases are distinguished: (i) resolving the faults separately, (ii) resolving the faults according to the worst case given by the classification task and finally, (iii) resolving the faults according to the best case given by the classification task.

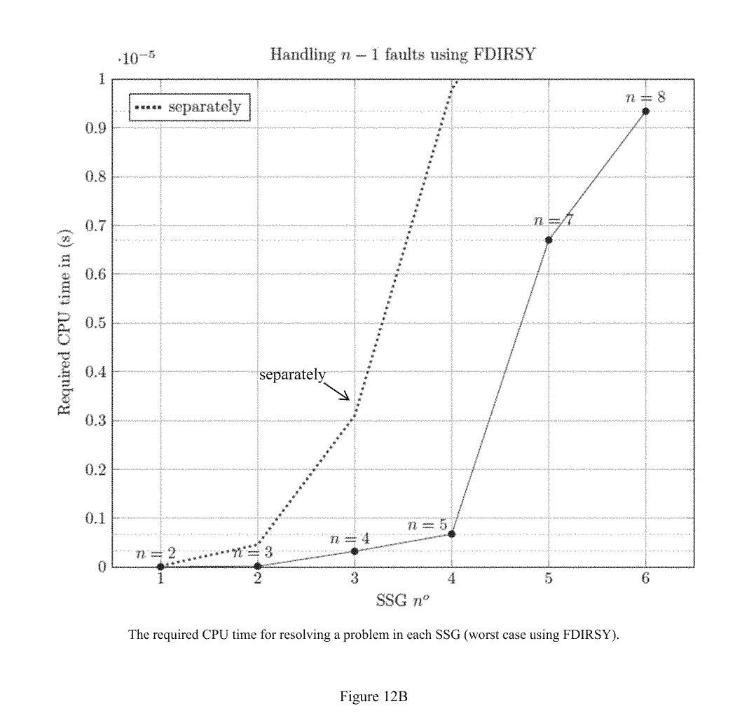

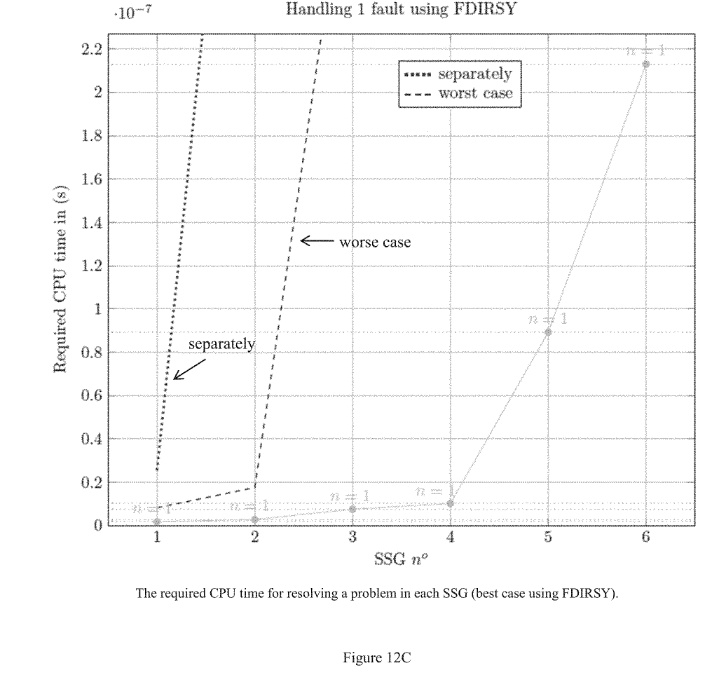

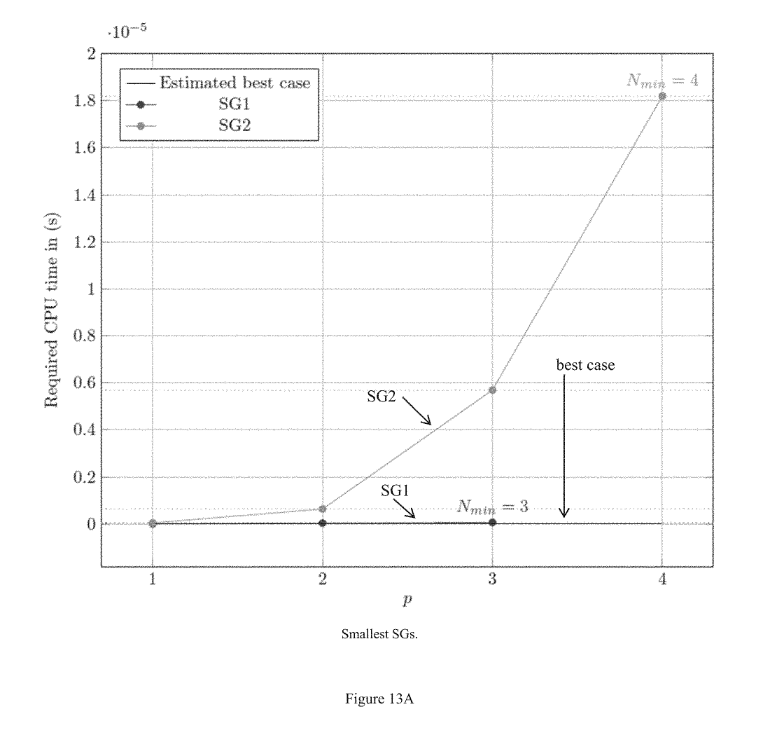

FIG. 12A illustrates the required CPU time (in Seconds) needed to resolve separately the faults occurring on a sub-grid (n>p). While the execution of a categorization task over the occurred faults may reduce the number of faults to be handled to p faults when p problems occurred, that is, resolving only one fault implies the resolution of the caused problem (both in case of dominance or equivalence). It is the best case as one fault per problem will be resolved. FIG. 12C illustrates this case. The worst case is observed, where there are n faults categorized by dominance for which the resolution of the dominant one is not possible. Then, at most the n−1 dominated ones need to be resolved as illustrated by FIG. 12B (such that n−1>p). It can be seen that, even for the worst case, the number of the faults to be resolved is reduced it is not necessary to proceed to resolve all of the faults separately but efficiently by investigating the dependencies between them. This advantage is particularly useful where it is necessary to manipulate large scale smart grids. FIGS. 12A, 12B, and 12C illustrate the gain in terms of required CPU time when resolving a problem p over smart sub-grids compared with resolving faults separately. The resolution of each fault implies the investigation of all the incoming emergency lines having sufficient remaining load to supply the failed component(s) corresponding to this fault.

Another advantage of the proposed fault categorization lies on the fault deduction and anticipation. In fact, the occurred fault is generally propagated to the other connected components. The new relations proposed accelerate the detection time of the consequent faults by deduction and violated constraints identification. The CPU time for detection (including the required time for deduction) does not exceed 1 μs for SG1, SG2 and SG3 and is equal to 1 μs for SG4 and SG5.

Many problems may occur at the same time over the same smart grid (one problem per smart sub-grid). This leads to the failure of more than one, and even multiple sub-grids. However, there is a need to have a minimum number of operating sub-grids to allow the recovery of the failed ones. This minimum number depends on the total number of smart sub-grids in the studied smart grids as well as their structure (containing large or small sub-grids, number of emergency lines, paths, etc.) and on their configuration (capacities of components, remaining loads, etc.).

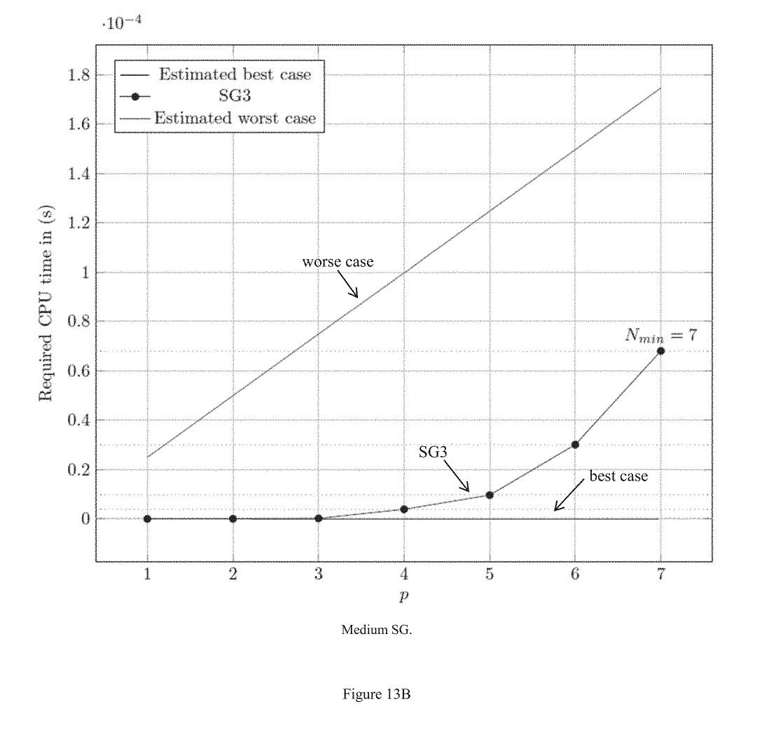

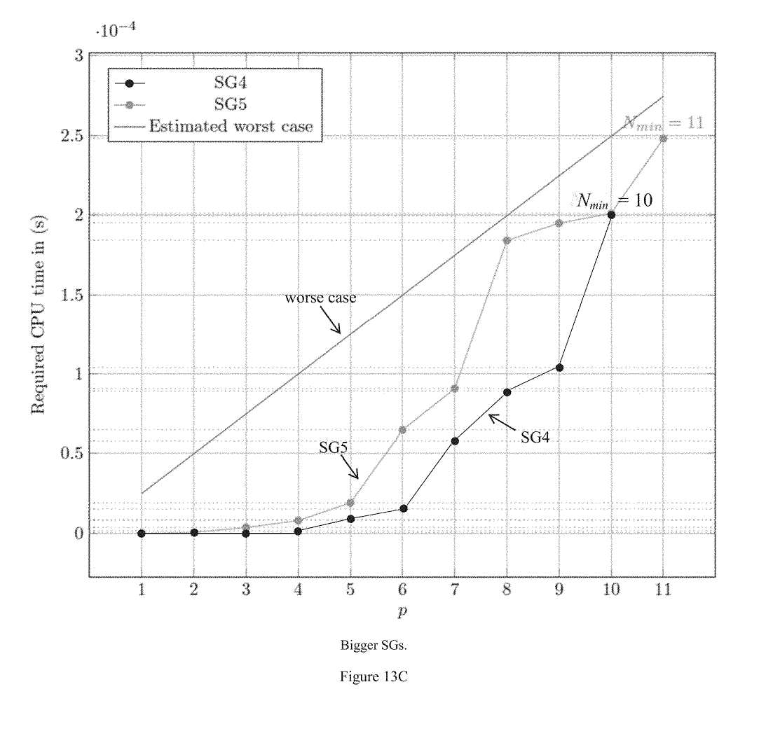

FIGS. 13A, 13B, and 13C illustrate the CPU time for resolving p=1, 2 and multiple problems over each of the studied smart grids. The structure and the size of the smart grid have an impact on the time needed to resolve the problem. Therefore, CPU time increases in terms of the size of the recovered sub-grids. In FIGS. 12A, 12B, and 12C, N represents the maximum number of problems to be recovered for each simulated smart grid.reover, given p problems, the best and worst required CPU times are estimated, respectively, by CPU_{bestcase} and CPU_{worstcase} and calculated as in equation (24). The first one is obtained based on the required CPU time for a local resolution of p problems on the smallest sub-grid (containing only 3 components) among all the studied smart sub-grids. While the second one is obtained from a non-local resolution of p problems occurring on the largest existing smart sub-grids (containing 12 components).

FIGS. 13A, 13B, and 13C illustrate the area of the required CPU time bounded by the best and worst cases. In the embodiment, the resolution CPU time does not exceed 1 ms for a problem number going up to 11 (including a number of faults>11 problems).

CPU_{best case}=p×CPU_{smallest SSG} CPU_{worst case}−p×CPU_{largest SSG} (24)

It is also important to note the communication cost. The number of the messages to be exchanged, denoted by n_{msg}, is constant. It is equal either to zero (when there is no instantiated mobile agent) or to the number of the existing paths. It is obtained by:

n_{msg}=1+Σᵢ₌₁ⁿ^{_{b}} children(bᵢ)−int_{comp} (25)

where n_{b} is the number of bifurcations over the recovered sub-grid going to the neighboring ones to be analyzed, b, corresponds to the i^{th} bifurcation and int_{comp} corresponds to the number of components having both children and fathers.

FIG. 14 illustrates the evolution of n_{msg} in terms of p and of the existing paths path_{SSG}. The points A(1,2,2), B(2,6,12), C(7,4,28) and D(10,6,60) represent the number of exchanged messages according to the format (p, path_{SSG}, n_{msg}). In the embodiment, communication cost is reduced by reducing the exchanged messages to only one per visited path. Throughout this specification, unless the context requires otherwise, the word “comprise” or variations such as “comprises” or “comprising”, will be understood to imply the inclusion of a stated integer or group of integers but not the exclusion of any other integer or group of integers.

Those skilled in the art will appreciate that the invention described herein is susceptible to variations and modifications other than those specifically described. The invention includes all such variation and modifications. The invention also includes all of the steps, features, formulations and compounds referred to or indicated in the specification, individually or collectively and any and all combinations or any two or more of the steps or features. Definitions for selected terms used herein may be found within the detailed description of the specification and apply throughout. Unless otherwise defined, all other scientific and technical terms used herein have the same meaning as commonly understood to one of ordinary skill in the art to which the invention belongs.

Although not required, the embodiments described with reference to the method, computer program, data signal and aspects of the system can be implemented via an application programming interface (API), an application development kit (ADK) or as a series of program libraries, for use by a developer, for the creation of software applications which are to be used on any one or more computing platforms or devices, such as a terminal or personal computer operating system or a portable computing device, such as a smartphone or a tablet computing system operating system, or within a larger server structure, such as a ‘data farm’ or within a larger transaction processing system.

Generally, as program modules include routines, programs, objects, components and data files that perform or assist in the performance of particular functions, it will be understood that the functionality of the software application may be distributed across a number of routines, programs, objects or components to achieve the same functionality as the embodiment and the broader invention claimed herein. Such variations and modifications are within the purview of those skilled in the art.

It will also be appreciated that where methods and systems of the present invention and/or embodiments are implemented by computing systems or partly implemented by computing systems then any appropriate computing system architecture may be utilised. This includes standalone computers, network computers and dedicated computing devices (such as field-programmable gate arrays).

Where the terms “computer”, “computing system” and “computing device” are used in the specification, these terms are intended to cover any appropriate arrangement of computer hardware for implementing the inventive concept and/or embodiments described herein.

Where terms such as “autonomous device” and “smart device” (and the like) are used in the specification, these terms are intended to cover any appropriate device which is capable of receiving a command and utilising the command to perform a function, which may be either a “physical” function (that is, movement) or a “virtual” function (e.g. interact with another device via electronic commands).

Where reference is made to cloud computing, the term refers to Internet-based computing, wherein shared resources, software, and/or information are provided to one or more computing devices on-demand via the Internet (or other communications network).

Where reference is made to communication standards, methods and/or systems/devices may transmit and receive data via a variety of forms: 3G, 4G (CDMA/GSM), Wi-Fi, Bluetooth, other radio frequency, optical, acoustic, magnetic, GPS/GPRS, or any other form or method of communication that may become available from time to time.

1. A system for fault detection and recovery of a network, comprising a network simulation module arranged to receive component data regarding a plurality of components which form the network and simulate the network, a modelling module arranged to utilise the simulated network to model a number of faults in the network to determine the effect of the faults on the network, and a recovery module arranged to determine a solution to the fault on the network.

2. The system of claim 1, wherein the recovery module determines the solution by firstly determining a solution to a dominant fault.

3. The system of claim 1, wherein the network simulation module simulates a set of sub-networks.

4. The system of claim 3, wherein the modelling module determines the solution by firstly determining a solution to a dominant fault in each sub-network.

5. The system of claim 1, wherein the system utilises a distributed architecture.

6. The system of claim 5, wherein the distributed architecture utilises static and mobile agents.

7. The system of claim 5, wherein the modelling module uses the distributed architecture to determine a strategy for ameliorating the fault and/or dominant fault in the network or the each-sub-network.

8. The system of claim 2, wherein the modelling module is arranged to classify the faults into one or more categories.

9. The system of claim 1, further including a communications module arranged to communicate the proposed solution to one or more of the components of a network.

10. A method for fault detection and recovery of a network, comprising the steps of receiving component data regarding a plurality of components which form the network and simulate the network, modelling the simulated network to model a number of faults in the network to determine the effect of the faults on the network, and determining a solution to the fault on the network.

11. The method of claim 10, wherein the recovery module determines the solution by firstly determining a solution to a dominant fault.

12. The method of claim 10, wherein a set of sub-networks are simulated.

13. The method of claim 12, comprising the further step of determining the solution by firstly determining a solution to a dominant fault in each sub-network.

14. The method of claim 10, comprising the further step of utilising a distributed architecture.

15. The method of claim 14, wherein the distributed architecture utilises static and mobile agents.

16. The method of claims 14, comprising the further step of utilising the distributed architecture to determine a strategy for ameliorating the fault and/or dominant fault in the network or the each-sub-network.

17. The method of claim 11, comprising the further step of classifying the faults into one or more categories.

18. The method of claim 10, comprising the further step of communicating the proposed solution to one or more of the components of a network.

19. A computer program incorporating at least one instruction, arranged to, when executed on a computing system, perform the method steps of claim 10.

20. A data signal encoding at least one instruction, arranged to, when received and executed on a computing system, perform the method steps of claim 10.

21. An electricity network incorporating a system in accordance with claim 1, wherein the at least one device includes a physical component which is operated by the system of claim 1.
